(19) United States
(12) Patent Application Publication
(10) Pub. No.: US 2004/0246628 A1
(43) Pub. Date: Dec. 9, 2004

(54) Magnetic recording apparatus in which adjacent signal tracks have substantially equal width and method for magnetic recording

(75) Inventors: Katsuya Kikuiri, Niigata-ken (JP); Takashi Saito, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/858,448

(22) Filed: Jun. 1, 2004

(30) Foreign Application Priority Data
Jun. 3, 2003 (JP) 2003-158573

(51) Int. Cl. G11B 5/52

(52) U.S. Cl. 360/271.5

(57) ABSTRACT

A magnetic recording apparatus includes first magnetic recording elements and second magnetic recording elements. The first magnetic recording elements precede the second magnetic recording elements. The second magnetic elements record signals to form second signal tracks between wide signal tracks previously formed by the first magnetic recording elements by recording signals so that the second signal tracks partly overlap the first signal tracks on both sides of the second signal tracks.

### BACKGROUND OF THE INVENTION

1. Field of the Invention

The present invention relates to, for example, a magnetic recording apparatus of a video system for recording a recording signal onto a magnetic tape, and a data magnetic recording apparatus for a computer. More particularly, the present invention relates to a magnetic recording apparatus which can stably record signals to form tracks on a magnetic recording medium, and a method for magnetic recording.

2. Description of the Related Art

In, for example, a magnetic recording apparatus of a video system or a magnetic recording/reproducing apparatus for storing computer data, magnetic heads are installed at a rotary cylinder of a rotary head device, a magnetic tape comes into contact with the rotary cylinder and is transported in a helical path, and the rotary cylinder rotates to perform a recording operation on the magnetic tape by a helical scanning method. For example, as shown in FIG. 10, after recording a signal to form a signal track a1 at a positive azimuth angle by one magnetic head, a signal is recorded to form a signal track b1 at a negative azimuth angle by another magnetic head so as to overlap a portion of the signal track a1. Thereafter, a signal track a2, a signal track b2, and a signal track a3 are similarly formed by recording signals in the direction of the arrows. FIG. 10 is a conceptual diagram for illustrating the formation of the signal tracks when magnetic head sliding surfaces are viewed from the back of the magnetic tape. The signal tracks are actually formed onto the front of the magnetic tape at angles set by the magnetic heads. For the sake of simplicity, the azimuth angles of the signal tracks formed by the magnetic head having a positive azimuth angle are represented by the angle of the magnetic head having a positive azimuth angle. (Such signal tracks are called “positive azimuth patterns” in the specification.) Similarly, the azimuth angles of the signal tracks formed by the magnetic head having a negative azimuth angle are represented by the angle of the magnetic head having a negative azimuth angle. (Such signal tracks are called “negative azimuth patterns” in the specification.)

In order to achieve high transfer rates, for example, what is called a multiple magnetic head comprising a plurality of magnetic heads for increasing the number of signal tracks that are formed at one time by recording signals has hitherto been variously designed (refer to Japanese Unexamined Patent Application Publication No. 2-183401).

In recent years, an increase in recording density has reduced the widths of signal tracks. Nowadays, the signal track width is down to approximately 2.0 μm.

When track widths are reduced, depending upon, for example, the mechanical precision of a rotary cylinder or the precision with which tilting of a magnetic head is adjusted, variations occur in the track widths during recording. As a result, wide and narrow signal tracks are formed during the recording, a signal track is formed so as to entirely overlap a previously formed signal track, or a gap is formed between signal tracks.

### SUMMARY OF THE INVENTION

Accordingly, the present invention has been achieved to overcome the aforementioned problems, and has as its object the provision of a magnetic recording apparatus which can stably record signals to form signal tracks with constant width on a magnetic recording medium.

To this end, according to one aspect of the present invention, A magnetic recording apparatus for recording signals to form first signal tracks and second signal tracks alternately arranged on a magnetic recording medium at a first azimuth angle and a second azimuth angle, respectively. The magnetic head comprises a rotary head device including a rotary cylinder and at least one pair of magnetic heads, the rotary cylinder having a base to which the at least one pair of magnetic heads are mounted, the at least one pair of magnetic heads having magnetic gaps with different azimuth angles, each magnetic head comprising a plurality of magnetic recording elements. The magnetic gaps are disposed in the magnetic recording elements. The recording width of a first magnetic head of the at least one pair of magnetic heads is greater than the recording width of a second magnetic head of the at least one pair of magnetic heads. The first magnetic head precedes the second magnetic head in a direction of rotation of the rotary cylinder. The second magnetic head forms the second signal tracks between the first signal tracks previously formed on the magnetic recording medium by the first magnetic head such that the second signal tracks partly overlap the first signal tracks on both sides of the second signal tracks.

In the present invention, signals are recorded to form first signal tracks at the same azimuth angle onto a magnetic recording medium by the first magnetic head of the at least one pair of magnetic heads (preceding the second magnetic head of the at least one pair of magnetic heads). Then, signals are recorded to form second signal tracks by the second magnetic head of the at least one pair of magnetic heads (following the first magnetic head) at an azimuth angle that is different from the azimuth angle of the first magnetic head and with a smaller recording width so that the second signal tracks partly overlap the first signal tracks on both sides of the respective second signal tracks. Therefore, adjacent signal tracks are formed at different azimuth angles by recording signals, and each set of alternately-adjacent signal tracks is formed at the same azimuth angle. Consequently, the signal tracks can be stably formed with a constant width by recording signals.

That is, by previously forming wide signal tracks by recording signals by the first magnetic head, even if what is called linearity error occurs in the mechanical precision of the rotary cylinder or the precision in adjusting the tilting of the magnetic head, magnetic recording elements of the second magnetic head record signals at the same time to make the signal widths constant.

If one of the at least one pair of magnetic heads is a multiple magnetic head in which the magnetic gaps of the magnetic recording elements have the same azimuth angle, the number of recording operations can be increased by rotation of the rotary cylinder, so that transfer rate can be increased. In addition, adjacent signal tracks can be formed at different azimuth angles by recording signals, and the widths of the signal tracks already formed on the magnetic recording medium can be restricted based on the magnetic gap intervals of the second magnetic head. Further, the larger the number of magnetic gaps in the multiple magnetic head, the smaller the effects of linearity error.

Accordingly, in the present invention, since the intervals between the magnetic gaps restrict the widths of the signal tracks on the magnetic recording medium, it is desirable that the multiple magnetic head be a thin-film magnetic head. By thin-film processing, the magnetic gap intervals can be determined with high precision. In addition, since the intervals between the magnetic gaps or tracks are easily reduced with high precision, the effects of linearity error can be further reduced. Further, the number of magnetic gaps is easily increased, which is advantageous for increasing recording density.

In the present invention, it is desirable that the at least one pair of magnetic heads are disposed within 90 degrees on the rotary cylinder. This is because the linearity error in helical scanning depending upon, for example, the mechanical precision of the rotary cylinder is reduced when the at least one pair of magnetic heads are disposed closer to each other.

It is desirable that the pair of magnetic heads be combined magnetic heads disposed on the base at the rotary cylinder because linearity error is reduced.

According to another aspect of the present invention, there is provided a method for recording signals to form first signal tracks and second signal tracks alternately arranged on a magnetic recording medium at a first azimuth angle and a second azimuth angle, respectively. The method comprises the steps of scanning the magnetic recording medium by at least one pair of magnetic heads having magnetic gaps with different azimuth angles, forming the first signal tracks onto the magnetic recording medium at the same time by a first magnetic head of the at least one pair of magnetic heads preceding a second magnetic head of the at least one pair of magnetic heads, and forming the second signal tracks between the first signal tracks at the same time by the second magnetic head so that the second signal tracks partly overlap the first signal tracks formed by the first magnetic head and disposed on both sides of the second signal tracks.

According to the method for magnetic recording of the present invention, even if what is called linearity error occurs in, for example, the mechanical precision of the rotary cylinder or the precision in adjusting the tilting of the magnetic heads, the magnetic recording elements of the second magnetic head of the at least one pair of magnetic heads record signals at the same time to make signal widths constant. In addition, since the at least one pair of magnetic heads perform recording operations without forming gaps, guard bands are not formed. Therefore, the second signal tracks are formed by recording signals so that they partly overlap the first signal tracks, as a result of which high-density recording is achieved.

### BRIEF DESCRIPTION OF THE DRAWINGS

FIG. 1 is a conceptual diagram for illustrating a recording method by a magnetic recording apparatus of a first embodiment of the present invention, and the relationship between the scanning positions of magnetic recording elements and that of a magnetic tape;

FIG. 2 shows an example of a rotary head device;

FIG. 3 illustrates magnetic heads mounted at the rotary head device;

FIG. 4 is a partial sectional view of a first magnetic head precedes a second magnetic head in the first embodiment of the present invention as seen from a medium opposing side of the magnetic head;

FIG. 5 is a partial sectional view of the second magnetic head disposed behind the first magnetic head in the first embodiment of the present invention as seen from a medium opposing side of the magnetic head;

FIG. 6 shows an example of a thin-film magnetic head;

FIG. 7 is a conceptual diagram for illustrating a recording method by a magnetic recording apparatus of a second embodiment of the present invention, and the relationship between the scanning positions of magnetic recording elements and that of a magnetic tape;

FIG. 8 is an example of a rotary head device;

FIG. 9 is a partial sectional view of multiple magnetic heads in the second embodiment of the present invention as seen from medium opposing sides of the multiple magnetic heads; and

FIG. 10 is a conceptual diagram for illustrating a recording method by a related magnetic recording apparatus, and the relationship between the scanning positions of magnetic recording elements and that of a magnetic tape.

### DESCRIPTION OF THE PREFERRED EMBODIMENTS

(First Embodiment)

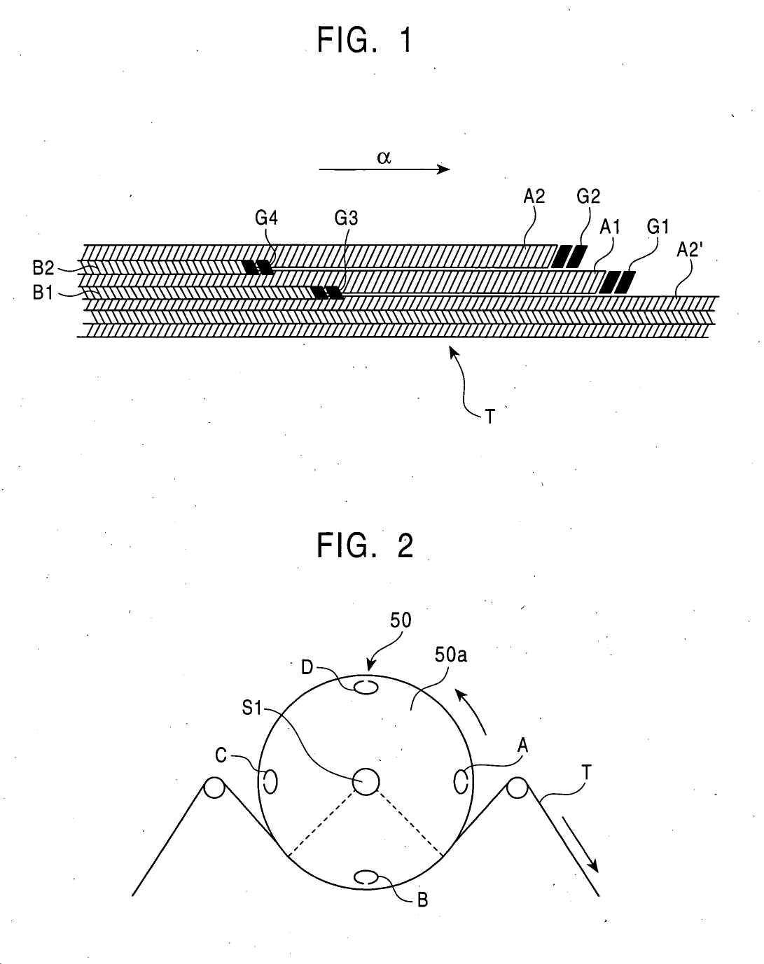

FIG. 1 is a conceptual diagram for showing the relationship between the positions of magnetic heads of a magnetic recording apparatus of the present invention and the position of a magnetic tape (magnetic recording medium) when the magnetic heads move along the magnetic tape to form signal tracks by recording signals onto the magnetic tape. FIG. 1 illustrates the formation of the signal tracks when magnetic head sliding surfaces are seen from the back of the magnetic tape. The signal tracks are actually formed onto the front of the magnetic tape at angles set by the magnetic heads. For the sake of simplicity, the azimuth angles of the signal tracks formed by the magnetic head having a positive azimuth angle are represented by the angle of the magnetic head having a positive azimuth angle. (Such signal tracks are called “positive azimuth patterns” in the specification.) Similarly, the azimuth angles of the signal tracks formed by the magnetic head having a negative azimuth angle are represented by the angle of the magnetic head having a negative azimuth angle. (Such signal tracks are called “negative azimuth patterns” in the specification.)

Recording elements of the magnetic heads shown in FIG. 1 constitute a magnetic recording/reproducing apparatus of a video system for recording signals onto or reproducing them from, for example, a magnetic tape T or constitute a data magnetic recording/reproducing apparatus for a computer. Magnetic recording elements G1, G2, G3, and G4 are shown at assumed positions with respect to the magnetic tape T.

The magnetic recording elements G1, G2, G3, and G4 shown in FIG. 1 can be disposed at a magnetic head A (a first magnetic head precedes a second magnetic head) and a magnetic head B (the second magnetic head disposed behind the first magnetic head) of a rotary head device 50 shown in FIG. 2 of the magnetic recording/reproducing apparatus. They may also be disposed at a magnetic head C and a magnetic head D. They may be disposed closer together.

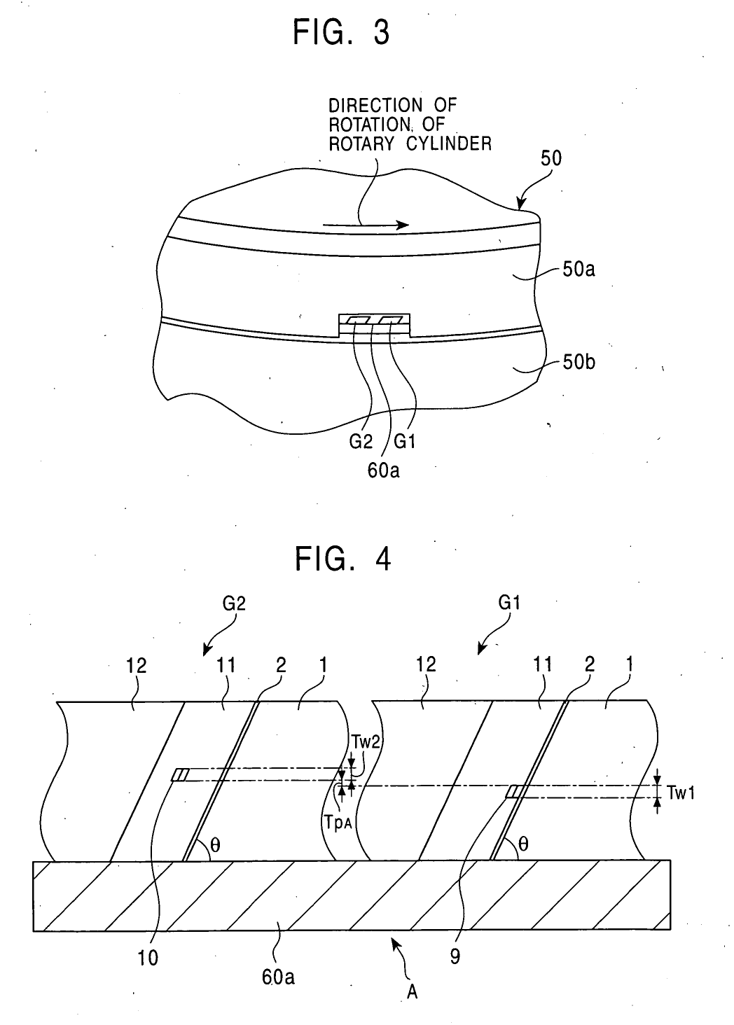

In the rotary head device 50 shown in FIG. 2 installed in the magnetic recording/reproducing apparatus, a stationary cylinder 50b shown in FIG. 3 is fixed, and a rotary cylinder 50a which is coaxial with the stationary cylinder is rotatably supported at the stationary cylinder and is rotationally driven by motor power in the direction of an arrow marked beside the rotary cylinder 50a shown in FIG. 2. As shown in FIG. 2, the magnetic tape T, which is a magnetic recording medium, is wound upon the rotary head device 50 at a predetermined angle in a helical path and runs in the direction of an arrow marked beside the magnetic tape T.

For example, in FIG. 2, the magnetic tape T is wound upon the rotary head device 50 at an angle of 90 degrees with respect to a rotational center S1 of the rotary cylinder 50a. The rotary cylinder 50a rotates along the wound portion of the magnetic tape T in order for the magnetic heads A, B, C, and D at the rotary cylinder 50a to scan the magnetic tape T. In FIG. 2, the magnetic head A and the magnetic head B provide functions of a magnetic recording apparatus, are defined as a pair, and are disposed 90 degrees from each other as viewed from the rotational center S1 of the rotary cylinder 50a. The magnetic head C and the magnetic head D provide functions of a magnetic reproducing apparatus, are defined as a pair, and are similarly disposed 90 degrees from each other at the rotary cylinder 50a. When the magnetic heads A to D scan the magnetic tape T, they provide functions of the magnetic recording/reproducing apparatus. The magnetic heads A to D are disposed 90 degrees from their adjacent magnetic heads at the rotary cylinder 50a.

As shown in FIG. 3, in the magnetic head A, the magnetic recording elements G1 and G2 are what are called combined heads disposed on a base 60a that is formed of nonmagnetic metal, such as brass, and that is disposed at the rotary cylinder 50a. The magnetic heads B to D, which are not shown, have the same structures.

It is desirable to use, for example, magnetoresistive elements for magnetic reproducing elements of the magnetic heads C and D because they make it easier to, for example, read out what is recorded on the magnetic tape with high density. For example, AMR elements or GMR (giant magnetoresistive) elements, such as spin-valve thin-film elements, may be used as the magnetoresistive elements.

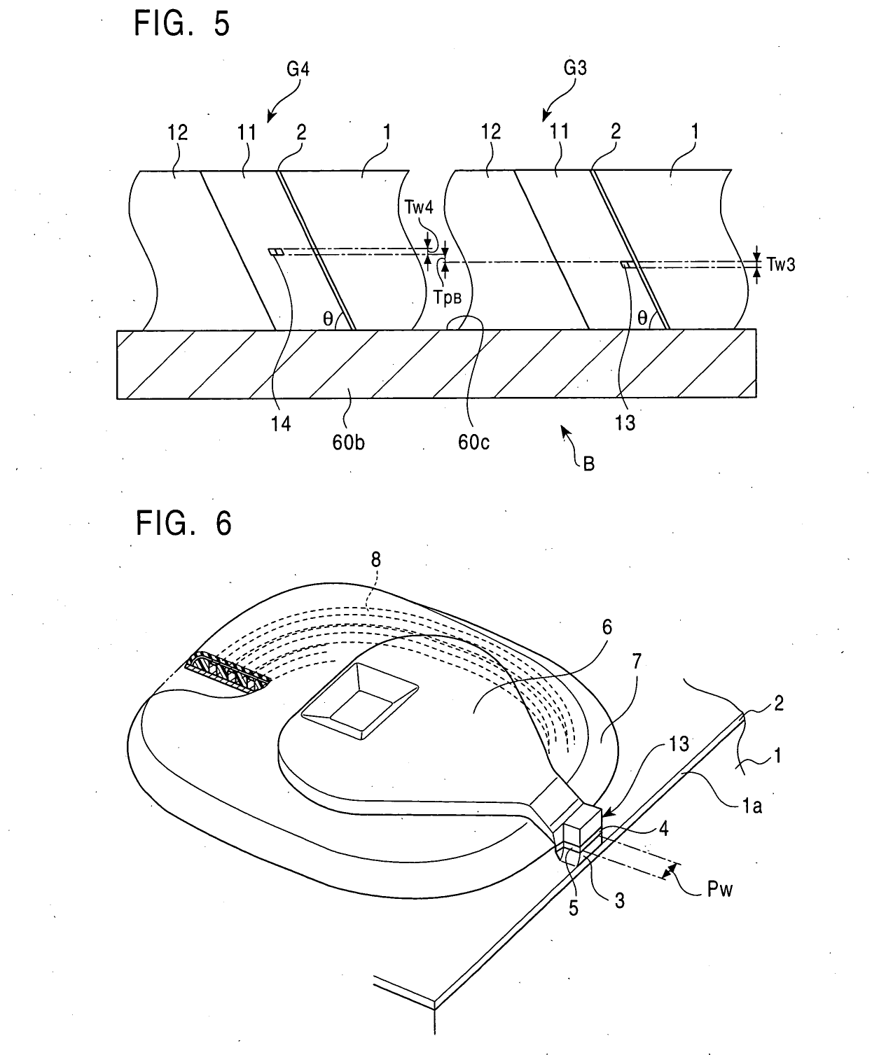

FIGS. 4 and 5 are partial enlarged views of the magnetic heads A and B, respectively, as seen from their medium opposing surfaces. The part between the magnetic recording elements G1 and G2 and that between the magnetic recording elements G3 and G4 will be omitted due to the size of the figures.

The magnetic head A shown in FIG. 4 has two magnetic recording elements G1 and G2 disposed on the base 60a formed of nonmagnetic metal. The azimuth angles of the two magnetic recording elements are what are called positive azimuth angles (measured clockwise on the rotary cylinder as viewed from the sliding surfaces), and are equal to each other.

The magnetic head B shown in FIG. 5 has two magnetic recording elements G3 and G4 disposed on a base 60b formed of nonmagnetic metal like the base 60a of the magnetic head A. The azimuth angles of the two magnetic recording elements G3 and G4 are what are called negative azimuth angles (measured counterclockwise on the rotary cylinder as viewed from the sliding surfaces), and are equal to each other.

The azimuth angle of the magnetic head A shown in FIG. 4 are opposite to that of the magnetic head B shown in FIG. 5. In each of the magnetic heads A and B, two magnetic recording elements are disposed on one base, so that the distance between the magnetic recording elements on the base is reduced. Therefore, the magnetic heads A and B are not easily affected by the mechanical precision of the rotary cylinder.

Next, the magnetic recording elements will be described taking the magnetic recording element G3 as an example with reference to FIG. 5. The magnetic recording elements in the embodiment can be formed with precise recording width of, for example, approximately 3 μm using thin-film technology. For example, in order to form the magnetic recording element G3, a thin-film magnetic head 13 (inductive head) is formed by thin-film technology above a substrate 1, formed of alumina titanium carbide, through an underlying layer 2, formed of an insulating material such as Al₂O₃ or SiO₂. A protective layer 11, formed of an insulating material, such as Al₂O₃ or SiO₂, is deposited onto the thin-film magnetic head 13, and a protective substrate 12, formed of alumina titanium carbide, is adhered to the protective layer 11.

As shown in FIG. 6, in the thin-film magnetic head 13, a gap layer 5, a coil layer 8, and an upper core layer 4 are stacked upon each other on a lower core layer 3. The lower core layer 3 is formed of a soft magnetic material, such as an Ni—Fe alloy. The gap layer 5 is formed of a nonmagnetic material, such as Al₂O₃, SiO₂, and NiP. The coil layer 8 is formed of an electrically conductive material such as Cu. The upper core layer 4 is formed of a soft magnetic material. An end surface between the upper core layer 4 and the lower core layer 3 and opposing the magnetic tape is used to write information onto the magnetic tape. The coil layer 8 is a pattern spirally formed in a plane on the lower core layer 3 through an insulating layer 7, and is covered by the insulating layer 7. An upper yoke layer 6 is formed on the insulating layer 7, is divided at a boundary of a magnetic pole base from the upper core layer 4 exposed at the sliding surface, and is magnetically connected to the upper core layer 4. The upper core layer 4, the gap layer 5, and the lower core layer 3 are deposited substantially in parallel onto a top surface la of the substrate 1.

Next, it is desirable that both sides or one side in the core width direction of the end surface of an end portion constituted by the upper core layer 4, the gap layer 5, and the lower core layer 3 be inclined by a predetermined angle with respect to the top surface 1a of the substrate 1. If the inclination angle is equal to or approximately equal to the azimuth angle at which tracks are formed on the magnetic tape by recording signals, it is possible to prevent smearing in the recording operation. In other words, the end surface is formed with a width which defines the recording width, and at least one side of the end surface is aligned in the longitudinal direction of a signal track. The inclination may be formed by, for example, scraping a portion of one or both sides in the core width direction of the end surface of the magnetic recording element by, for example, ion milling from a magnetic tape opposing side.

The end surface does not need to be inclined due to, for example, a wide recording width. For example, since an end of a signal pattern recorded by a magnetic recording element which precedes another recording element is finally overlapped by another signal pattern recorded by the another magnetic recording element, both sides of the end surface in the core width direction are formed at right angles without inclinations with respect to the top surface 1a of the substrate 1. In order to prevent smearing in the recording operation, the another magnetic recording element is such that one or both sides of an end surface in the core width direction are inclined with respect to the top surface 1a of the substrate 1, so that the signal track recording width is more stabilized.

The width of a magnetic gap in the end surface shown in FIG. 6 is equal to a track width Pw. As shown in FIG. 5, if the azimuth angle with respect to the top surface 60c disposed parallel to the direction of rotation of the rotary cylinder is, for example, θ, the recording width of the magnetic recording element G3 is Tw3=Pw×cos θ. Information is recorded with this width onto the magnetic tape.

The azimuth angle of a thin-film magnetic head 14 shown in FIG. 5 is the same as that of the thin-film magnetic head 13. Its recording width Tw4 is equal to Tw3. Since a signal track B1 formed by the thin-film magnetic head 13 by recording a signal and a signal track B2 formed by the thin-film magnetic head 14 by recording a signal are separated by a predetermined interval, heights (lengths) in a direction perpendicular to the direction of rotation of the rotary cylinder need to be different, that is, heights from the top surface 60c situated parallel to the direction of rotation of the rotary cylinder are different. The distance between an end of the gap layer of the thin-film magnetic head 13 and an end of a gap layer of the thin-film magnetic head 14 in a direction perpendicular to the direction of rotation of the rotary cylinder, that is, what is called a track interval Tp_{B}, becomes the interval between the signal tracks B1 and B2 when information is recorded onto the magnetic tape.

Thin-film magnetic heads 9 and 10 shown in FIG. 4 have substantially the same structures as the thin-film magnetic heads 13 and 14. Recording widths Tw1 and Tw2 of the respective thin-film magnetic heads 9 and 10 are equal to each other, but are greater than the recording widths Tw3 and Tw4 of the respective thin-film magnetic heads 13 and 14.

A track interval width Tp_{A} between the thin-film magnetic head 9 and the thin-film magnetic head 10 is less than the recording widths Tw3 and Tw4 of the respective thin-film magnetic heads 13 and 14. A portion of a signal track A1 formed by the thin-film magnetic head 9 by recording a signal may be overlapped by a signal track A2 formed by the thin-film magnetic head 10 by recording a signal without the track interval Tp_{A}.

Next, the operation of the magnetic recording apparatus of the present invention will be described. As shown in FIG. 1, when, for example, the magnetic heads A and B at the rotary cylinder 50a scan the magnetic tape and record signals onto it, the magnetic recording elements G1, G2, G3, and G4 having predetermined azimuth angles form signal tracks by moving along the magnetic tape T in the direction of arrow α. The magnetic recording elements G3 and G4 move along the magnetic tape T in the direction of arrow α between a signal track A2′ and the signal track A1 and the signal tracks A1 and A2, respectively, so that the signal track B1 partly overlaps the signal tracks A2′ and A1 and the signal track B2 partly overlaps the signal tracks A1 and A2. As a result, the signal tracks B1 and B2 are formed by recording signals onto the magnetic tape T obliquely from the magnetic tape transport direction. The method for forming signal tracks obliquely from the magnetic tape T transport direction by recording is called a helical scanning method.

For example, with respect to the signal track A2′ already formed by the magnetic recording element G2 of the magnetic head A prior to one rotation of the rotary cylinder 50a, the magnetic recording elements G1 and G2 of the magnetic head A form the signal tracks A1 and A2 at the same time with the same azimuth angle (form positive azimuth patterns) while maintaining the track interval Tp_{A}.

Next, the magnetic recording element G3 of the magnetic head B records a signal to form the signal track B1 at an azimuth angle that is different from those of the signal tracks A2′ and A1 (form a negative azimuth pattern) so that the signal track B1 overlaps facing edges of the signal tracks A2′ and A1. At the same time, the magnetic recording element G4 of the magnetic head B records a signal to form the signal track B2 at an azimuth angle that is different from those of the signal tracks A2′ and A1 (forms a negative azimuth pattern) so that the signal track B2 overlaps facing edges of the signal tracks A1 and A2. The magnetic recording elements G3 and G4 of the magnetic head B move while maintaining the predetermined track interval Tp_{B}.

Therefore, the second magnetic head records signals to form signal tracks so that the signal tracks overlap facing sides of signal tracks already formed on the magnetic tape with the same azimuth angle by the first magnetic head. Since the azimuth angles of the first magnetic head and the second magnetic head are different, the signal tracks A1 and A2 and the signal tracks B1 and B2 adjacent thereto shown in FIG. 1 are formed with different azimuth angles by recording signals. In other words, adjacent signal tracks A2′ and B1, B1 and A1, A1 and B2, and B2 and A2 are formed with different azimuth angles and each set of alternately-adjacent signal tracks is formed with the same azimuth angle.

In the recording method illustrated in FIG. 1, signals are recorded to form signal tracks so that they partly overlap signal tracks adjacent thereto, without guard bands being formed between the signal tracks A2′ and B1, B1 and A1, A1 and B2, and B2 and A2. By the degree of overlap, the widths of the signal tracks that have been partly overlapped are restricted to predetermined widths, so that high-density recording is achieved.

The recording widths Tw1 and Tw2 of the magnetic head A are greater than the recording widths Tw3 and Tw4 of the magnetic head B. Therefore, the signal tracks A1 and A2 are formed with larger widths by recording signals onto the magnetic tape than the signal tracks B1 and B2. When a signal is recorded to form a signal track by the second magnetic head so that the signal track overlaps facing edges of two wide signal tracks previously formed by recording signals by the first magnetic head, the widths of the signal tracks adjacent to the signal tracks formed by the magnetic head B can be equal to each other.

Considering that the rotary cylinder shakes vertically, it is desirable that the recording widths Tw1 and Tw2 of the magnetic head A are greater than the sum of twice the linearity error of the rotary cylinder and the respective recording widths Tw3 and Tw4 of the magnetic head B. When the recording widths Tw3 and Tw4 are equal to the track interval Tp_{B}, signal track are formed between respective two wide signal tracks previously formed by the first magnetic head. Therefore, the widths of the signal tracks are substantially equal to each other.

Although, in the magnetic recording apparatus of the present invention, what is called linearity error does occur in, for example, the mechanical precision of the rotary cylinder or the precision in adjusting the tilting of the magnetic heads, the linearity error is minimized as a result of adjusting the widths of the previously formed wide signal tracks by forming signal tracks between these wide signal tracks by the second magnetic head. By the adjustment, the signal tracks adjacent to the signal tracks formed by the second magnetic head have substantially the same width. In order for the second magnetic head to be capable of adjusting the widths of neighboring signal tracks, the track interval Tp_{B} needs to be set with high precision. Since, in the embodiment, the magnetic recording elements G3 and G4 are what are called combined heads mounted to the same base formed of a nonmagnetic metal is used, a plurality of recording operations can be carried out at the same time with high precision without being affected by the linearity error.

It is desirable that the recording widths Tw3 and Tw4 of the respective magnetic recording elements G3 and G4 of the magnetic head B be greater than the interval between the magnetic recording elements G1 and G2 of the magnetic head A, that is, the track interval Tp_{A}. If the recording widths Tw3 and Tw4 are smaller than the track interval Tp_{A}, not only is it impossible to record a signal and form signal tracks by the second magnetic head onto facing sides of respective two wide signal tracks previously formed by recording signals by the first magnetic head, but also an area which is not subjected to recording is produced, so that recording capacity is reduced.

Even if the recording widths Tw3 and Tw4 are equal to the track interval Tp_{A}, the widths of the signal tracks adjacent to the signal tracks formed by the magnetic head B cannot be made substantially equal by recording a signal and forming a signal track by the second magnetic head onto facing sides of two wide signal tracks previously formed by recording signals by the first magnetic head.

The magnetic recording apparatus of the present invention is capable of performing what is called a read-after-write operation in which immediately after the signal tracks A1, A2, B1, and B2 shown in FIG. 1 are formed by recording signals, the magnetic heads C and D reproduce what is magnetically recorded as can be seen from FIG. 2.

Although in the embodiment two magnetic recording elements are formed on a base formed of nonmagnetic metal, more than two magnetic recording elements may be mounted. In addition, although the magnetic recording elements are described as having thin-film magnetic heads, they may have composite magnetic heads comprising a thin-film magnetic head (inductive head) and a reproducing magnetic head (such as an MR head).

(Second Embodiment)

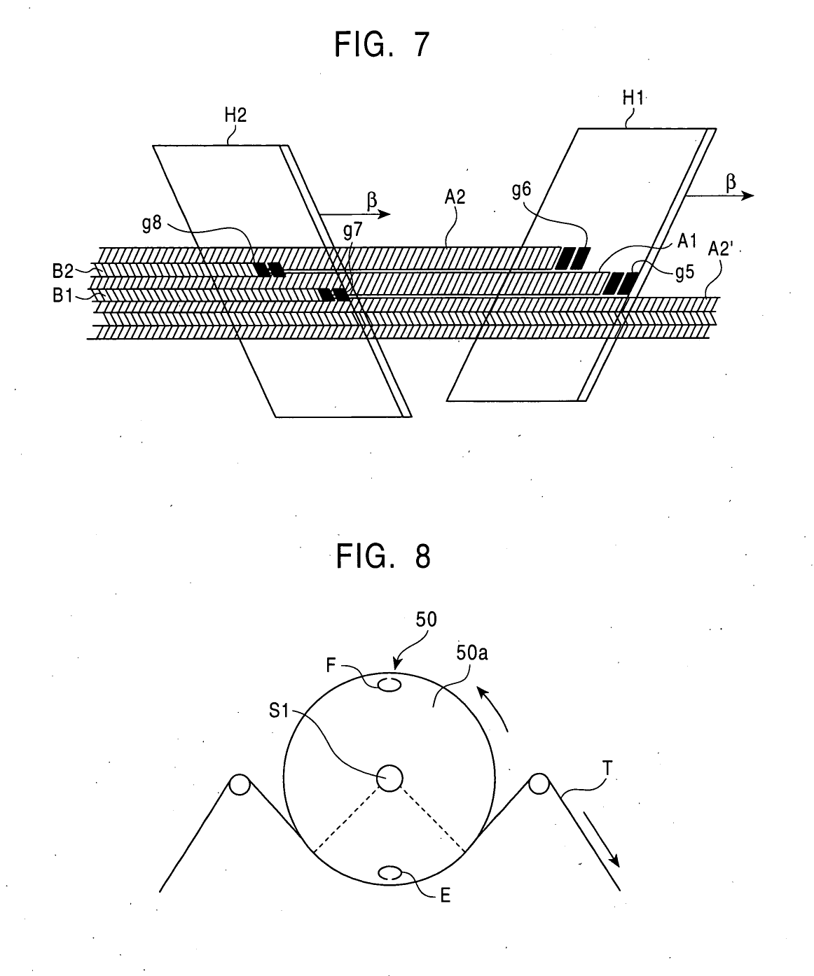

FIG. 8 is a conceptual diagram for showing the relationship between the positions of magnetic heads of a magnetic recording apparatus of a second embodiment of the present invention and a magnetic tape (magnetic recording medium) when the magnetic heads move along the magnetic tape to form signal tracks by recording signals onto the magnetic tape. In the description below, corresponding parts to those in the first embodiment are given the same reference numerals. FIG. 7 is a conceptual diagram for illustrating the formation of the signal tracks when magnetic head sliding surfaces are viewed from the back of the magnetic tape. The signal tracks are actually formed onto the front of the magnetic tape at angles set by the magnetic heads. For the sake of simplicity, the azimuth angles of the signal tracks formed by the magnetic head having a positive azimuth angle are represented by the angle of the magnetic head having a positive azimuth angle. (Such signal tracks are called “positive azimuth patterns.”) Similarly, the azimuth angles of the signal tracks formed by the magnetic head having a negative azimuth angle are represented by the angle of the magnetic head having a negative azimuth angle. (Such signal tracks are called “negative azimuth patterns.”)

Symbols H1 and H2 shown in FIG. 7 denote what are called multiple magnetic heads each comprising a plurality of magnetic recording elements. (The magnetic head H1 is a first magnetic head precedes the magnetic head H2. The magnetic head H2 is a second magnetic head disposed behind the first magnetic head.) Symbols g5, g6, g7, and g8 denote assumed positions of the magnetic recording elements (thin-film magnetic heads) along a magnetic tape T.

The thin-film magnetic heads g5, g6, g7, and g8 shown in FIG. 7 may be disposed in a magnetic head E of a rotary head device 50 of a magnetic recording/reproducing apparatus shown in FIG. 8.

In the rotary head device 50 shown in FIG. 8 installed in the magnetic recording/reproducing apparatus, the stationary cylinder 50b shown in FIG. 3 is fixed, and the rotary cylinder 50a which is coaxial with the stationary cylinder is supported at the stationary cylinder and is rotationally driven by motor power in the direction of an arrow marked beside the rotary cylinder 50a shown in FIG. 8. As shown in FIG. 8, the magnetic tape T, which is a magnetic recording medium, is wound upon the rotary head device 50 at a predetermined angle in a helical path and runs in the direction of an arrow marked beside the magnetic tape T.

For example, in FIG. 8, the magnetic tape T is wound upon the rotary head device 50 at an angle of 90 degrees with respect to a rotational center S1 of the rotary cylinder 50a. The rotary cylinder 50a rotates along the wound portion of the magnetic tape T in order for the magnetic head E and a magnetic head F at the rotary cylinder 50a to scan the magnetic tape T. In FIG. 8, the magnetic head E provides functions of a magnetic recording apparatus, and the magnetic head F provides functions of a magnetic reproducing apparatus. Although the magnetic heads E and F are disposed 180 degrees from each other with respect to the rotational center S1 of the rotary cylinder 50a, they may be disposed any degrees apart from each other, desirably between 90 to 180 degrees from each other.

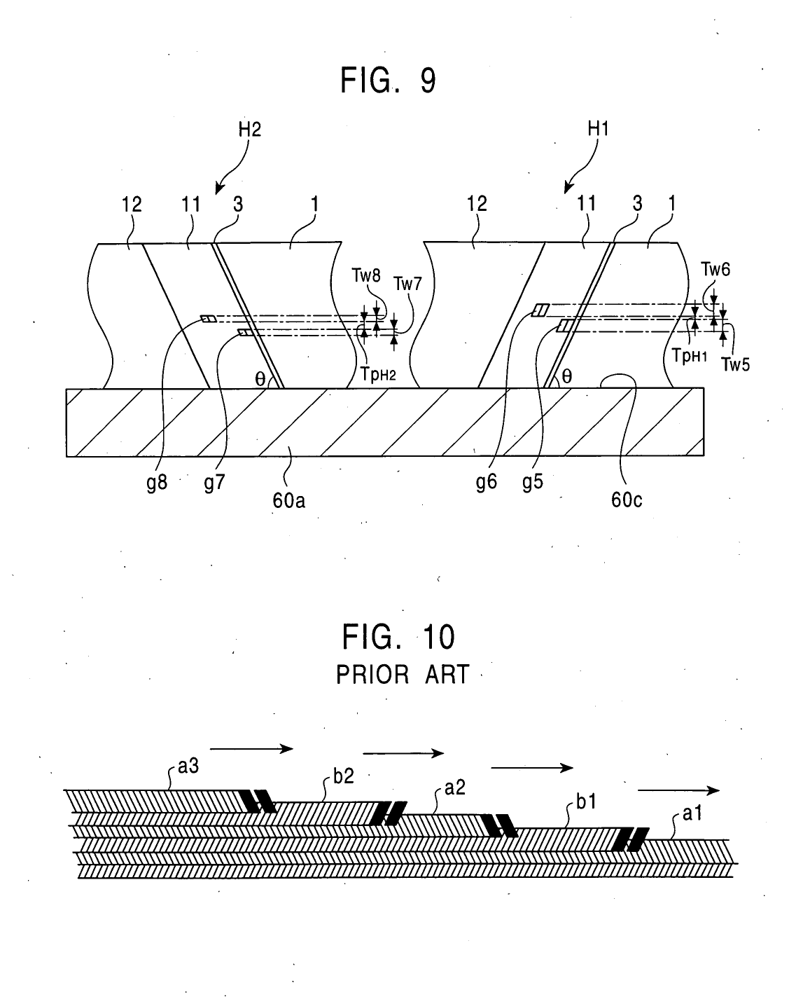

As shown in FIG. 9, in the magnetic head E, the multiple magnetic heads H1 and H2 are what are called combined heads disposed on a base 60a that is formed of a nonmagnetic metal, such as brass, and that is disposed on the rotary cylinder 50a as in the embodiment shown in FIG. 3. It is desirable to use, for example, magnetoresistive elements for magnetic reproducing elements of the magnetic head F because they make it easier to, for example, read out what is recorded on the magnetic tape with high density. For example, AMR elements or GMR (giant magnetoresistive) elements, such as spin-valve thin-film elements, may be used as the magnetoresistive elements.

FIG. 9 is a partial enlarged view of the magnetic head E as seen from its medium opposing surface. The multiple magnetic heads H1 and H2 are defined as a pair, are combined heads, and are disposed at opposing locations and at very small angles as viewed from the rotational center S1 of the rotary cylinder 50a.

The magnetic head F is also disposed on the rotary cylinder 50a with reproducing multiple elements (not shown) disposed on a base. The magnetic heads E and F scan the magnetic tape T to provide functions of a magnetic recording/reproducing apparatus. The part between the multiple magnetic recording heads H1 and H2 will be omitted due to the size of the figure.

The azimuth angles of the two magnetic recording elements of the multiple magnetic head H1 shown in FIG. 9 are what are called positive azimuth angles, and are equal to each other. The azimuth angles of the two magnetic recording elements of the multiple magnetic head H2 are what are called negative azimuth angles, and are equal to each other. From FIG. 9, it can be seen that the azimuth angles of the multiple magnetic heads H1 and H2 are opposite angles.

The pair of multiple magnetic heads are disposed on one base, so that the distance between the multiple magnetic heads on the base is reduced. Therefore, the effects of the mechanical precision of the rotary cylinder are considerably reduced.

Next, for example, in order to form the multiple magnetic heads H1 and H2, the thin-film magnetic heads (inductive heads) g5, g6, g7, and g8 are formed by thin-film technology above substrates 1, formed of alumina titanium carbide, through an underlying layer 2, formed of an insulating material such as Al₂O₃ or SiO₂. A protective layer 11, formed of an insulating material, such as Al₂O₃ or SiO₂, is deposited on the thin-film magnetic heads, and a protective substrate 12, formed of alumina titanium carbide, is adhered to the protective layer 11. Accordingly, the multiple magnetic heads H1 and H2 have the same structures as, for example, the magnetic recording elements G1 and G3 in the first embodiment.

The multiple magnetic head H1 only differs from the magnetic recording element G1 in the first embodiment in that the multiple magnetic head H1 has one more thin-film magnetic head disposed through the protective layer 11. Similarly, the multiple magnetic head H2 differs from the magnetic recording element G3 in the first embodiment in that the multiple magnetic head H2 has one more thin-film magnetic head disposed through the protective layer 11.

The thin-film magnetic heads g5, g6, g7, and g8 correspond to the thin-film magnetic heads in the first embodiment and shown in FIG. 6, so that they will not be described in detail here.

Recording widths Tw5 and Tw6 of the respective thin-film magnetic heads g5 and g6 shown in FIG. 9 are equal to each other. Since a signal track A1 formed by recording a signal by the thin-film magnetic head g5 and a signal track A2 formed by recording a signal by the thin-film magnetic head g6 are separated by a predetermined interval, heights (lengths) in a direction perpendicular to the direction of rotation of the rotary cylinder need to be different, that is, heights from a top surface 60c disposed parallel to the direction of rotation of the rotary cylinder are different. The distance between an end of a gap layer of the thin-film magnetic head g5 and an end of a gap layer of the thin-film magnetic head g6 in a direction perpendicular to the direction of rotation of the rotary cylinder, that is, what is called a track interval Tp_{H1}, becomes the interval between the signal tracks A1 and A2 when information is recorded onto the magnetic tape.

The recording widths Tw5 and Tw6 of the respective thin-film magnetic heads g5 and g6 are greater than recording widths Tw7 and Tw8 of the respective thin-film magnetic heads g7 and g8. The track interval Tp_{H1} between the thin-film magnetic heads g5 and g6 is less than the recording widths Tw7 and Tw8 of the respective thin-film magnetic heads g7 and g8. A portion of the signal track A1 formed by recording a signal by the thin-film magnetic head g5 may be overlapped by the signal track A2 formed by recording a signal by the thin-film magnetic head g6 without the track interval Tp_{H1}.

The thin-film magnetic head g7 shown in FIG. 9 has the same azimuth angle as the thin-film magnetic head g8, and the recording widths Tw7 and Tw8 are equal to each other. Since a signal track B1 formed by recording a signal by the thin-film magnetic head g7 and a signal track B2 formed by recording a signal by the thin-film magnetic head g8 are separated by a predetermined interval, heights (lengths) in a direction perpendicular to the direction of rotation of the rotary cylinder need to be different, that is, heights from the top surface 60c disposed parallel to the direction of rotation of the rotary cylinder are different.

The distance between an end of a gap layer of the thin-film magnetic head g7 and an end of a gap layer of the thin-film magnetic head g8 in a direction perpendicular to the direction of rotation of the rotary cylinder, that is, what is called a track interval Tp_{H2}, becomes the interval between the signal tracks B1 and B2 when information is recorded onto the magnetic tape.

Next, the operation of the magnetic recording apparatus of the present invention will be described. As shown in FIG. 7, when, for example, the magnetic heads H1 and H2 at the rotary cylinder 50a scan the magnetic tape and record signals onto it, the magnetic recording elements g5, g6, g7, and g8 having predetermined azimuth angles form signal tracks by moving along the magnetic tape T in the direction of arrow β. The thin-film magnetic heads g7 and g8 move along the magnetic tape T in the direction of arrow β so that the signal tracks B1 and B2 partly overlap the signal tracks A1 and/or A2. As a result, the signal tracks B1 and B2 are formed by recording signals onto the magnetic tape T obliquely from the magnetic tape transport direction.

For example, with respect to a signal track A2′ already formed by the magnetic recording element g6 of the magnetic head H1 prior to one rotation of the rotary cylinder 50a, the magnetic recording elements g5 and g6 of the multiple magnetic head H form the signal tracks A1 and A2 at the same time with the same azimuth angle (form positive azimuth patterns) while maintaining the track interval Tp_{H1}.

Next, the magnetic recording element g7 of the multiple magnetic head H2 records a signal to form the signal track B1 at an azimuth angle that is different from those of the signal tracks A2′ and A1 (form a negative azimuth pattern) so that the signal track B1 overlaps facing edges of the signal tracks A2′ and A1. At the same time, the magnetic recording element g8 of the multiple magnetic head H2 records a signal to form the signal track B2 at an azimuth angle that is different from those of the signal tracks A2′ and A1 (forms a negative azimuth pattern) so that the signal track B2 overlaps facing edges of the signal tracks A1 and A2.

The magnetic recording elements g7 and g8 of the multiple magnetic head H2 move while maintaining the predetermined track interval Tp_{H2}. Therefore, the second magnetic head records signals to form signal tracks so that the signal tracks overlap facing sides of signal tracks already formed on the magnetic tape with the same azimuth angle by the first magnetic head.

Since the azimuth angles of the first magnetic head and the second magnetic head are different, the signal tracks A1 and A2 and the adjacent signal tracks B1 and B2 shown in FIG. 7 are formed with different azimuth angles by recording signals. In other words, adjacent signal tracks are formed with different azimuth angles and each set of alternately-adjacent signal tracks is formed with the same azimuth angle.

In the recording method illustrated in FIG. 1, signals are recorded to form signal tracks so that they partly overlap signal tracks adjacent thereto, without guard bands being formed between the signal tracks A2′ and B1, B1 and A1, A1 and B2, and B2 and A2. By the degree of overlap, the widths of the signal tracks that have been partly overlapped are restricted to predetermined widths, so that high-density recording is achieved.

It is desirable that front magnetic recording elements and magnetic recording elements disposed behind the front magnetic recording elements scan in an alternate manner in order to form the signal tracks by recording signals at high density without gaps. It is also desirable that the number of front magnetic recording elements and those that are disposed behind the front magnetic recording elements are the same.

The recording widths Tw5 and Tw6 of the multiple magnetic head H1 are greater than the recording widths Tw7 and Tw8 of the multiple magnetic head H2. Therefore, the signal tracks A1 and A2 are formed with larger widths than the signal tracks B1 and B2 by recording signals onto the magnetic tape. When a signal is recorded to form a signal track by the second multiple magnetic head so that the signal track overlaps facing edges of two wide signal tracks previously formed by recording signals by the first multiple magnetic head, the widths of neighboring signal tracks can be equal to each other. Although, in the magnetic recording apparatus of the present invention, what is called linearity error does occur in, for example, the mechanical precision of the rotary cylinder or the precision in adjusting the tilting of the magnetic heads, the widths of the previously formed wide signal tracks are adjusted by forming signal tracks between these wide signal tracks by the second magnetic head. By the adjustment, the neighboring signal tracks have substantially the same width.

Considering that the rotary cylinder shakes vertically, it is desirable that the recording widths Tw5 and Tw6 of the magnetic head H1 are greater than the sum of twice the linearity error of the rotary cylinder and the respective recording widths Tw7 and Tw8 of the magnetic head H2. When the recording widths Tw7 and Tw8 are equal to the track interval Tp_{H2}, signal tracks are formed between respective two wide signal tracks previously formed by the first magnetic head. Therefore, the widths of the signal tracks are substantially equal to each other.

In order for the second multiple magnetic head to be capable of adjusting the widths of neighboring signal tracks, the track interval Tp_{H2} needs to be set with high precision. Since, in the embodiment, the thin-film magnetic heads g7 and g8 are formed on the same wafer by thin-film technology, Tp_{H2} is very precise. Therefore, a plurality of recording operations can be carried out at the same time with high precision without being affected by the linearity error.

It is desirable that the recording widths Tw7 and Tw8 of the respective magnetic recording elements g7 and g8 of the multiple magnetic head H2 be greater than the interval between the magnetic recording elements g5 and g6 of the multiple magnetic head H1, that is, the track interval Tp_{H1}. If the recording widths Tw7 and Tw8 are smaller than the track interval Tp_{H1}, not only is it impossible to record a signal and form signal tracks by the second magnetic head onto facing sides of respective two wide signal tracks previously formed by recording signals by the first magnetic head, but also an area which is not subjected to recording is produced, so that recording capacity is reduced.

Even if the recording widths Tw7 and Tw8 are equal to the track interval Tp_{H1}, the widths of neighboring signal tracks cannot be made substantially equal by recording a signal and forming a signal track by the second magnetic head onto facing sides of two wide signal tracks previously formed by recording signals by the first magnetic head.

The magnetic recording apparatus of the present invention is capable of performing what is called a read-after-write operation in which after the signal tracks A1, A2, B1, and B2 shown in FIG. 7 are formed by recording signals, the magnetic head F reproduces what is magnetically recorded as can be seen from FIG. 8. The transfer rate can be increased by further mounting a plurality of magnetic heads that are like the magnetic heads E and F to the rotary cylinder 50a.

Although the multiple magnetic heads are described as having two thin-film magnetic heads disposed on a base formed of nonmagnetic metal, they may have three or more thin-film magnetic heads. In this case, the track intervals are precise due to the use of thin-film technology, so that the effect of linearity error is eliminated, and the transfer rate by one rotation of the rotary cylinder is increased.

Although in the embodiment two multiple magnetic heads are disposed on a base formed of nonmagnetic metal, more than two multiple magnetic heads may be mounted. In addition, although the magnetic recording elements are described as being thin-film magnetic heads, they may be composite magnetic heads comprising a thin-film magnetic head (inductive head) and a reproducing magnetic head (such as an MR head).

According to the present invention described in detail above, when signals are recorded to form signal tracks by the second magnetic head onto facing edges of two or more wide signal tracks previously formed on the magnetic recording medium by recording signals by the first magnetic head, the widths of the neighboring tracks can be equal to each other. Even if what is called linearity error occurs in the mechanical precision of the rotary cylinder or the precision in adjusting the tilting of the magnetic head in the magnetic recording apparatus, the neighboring signal tracks can have substantially equal width. Therefore, variations in reproduction signals are restricted compared to those in related magnetic recording apparatuses.

1. A magnetic recording apparatus for recording signals to form first signal tracks and second signal tracks alternately arranged on a magnetic recording medium at a first azimuth angle and a second azimuth angle, respectively, the magnetic head comprising:
a rotary head device including a rotary cylinder and at least one pair of magnetic heads, the rotary cylinder having a base to which said at least one pair of magnetic heads are mounted, said at least one pair of magnetic heads having magnetic gaps with different azimuth angles, each magnetic head comprising a plurality of magnetic recording elements,
the magnetic gaps are disposed in the magnetic recording elements,
a recording width of a first magnetic head of said at least one pair of magnetic heads is greater than a recording width of a second magnetic head of said at least one pair of magnetic heads,
the first magnetic head precedes the second magnetic head in a direction of rotation of the rotary cylinder, and
the second magnetic head forms the second signal tracks between the first signal tracks previously formed on the magnetic recording medium by the first magnetic head such that the second signal tracks partly overlap the first signal tracks on both sides of the second signal tracks.

2. A magnetic recording apparatus according to claim 1, wherein one of said at least one pair of magnetic heads is a multiple magnetic head in which the magnetic gaps in the plurality of magnetic recording elements have the same azimuth angle.

3. A magnetic recording apparatus according to claim 1, wherein each magnetic gap is defined by a thin-film magnetic head.

4. A magnetic recording apparatus according to claim 1, wherein said at least one pair of magnetic heads are disposed within 90 degrees from each other on the rotary cylinder.

5. A magnetic recording apparatus according to claim 1, wherein said at least one pair of magnetic heads are combined magnetic heads disposed on a base at the rotary cylinder.

6. A magnetic recording apparatus according to claim 2, wherein each magnetic gap is defined by a thin-film magnetic head.

7. A magnetic recording apparatus according to claim 2, wherein said at least one pair of magnetic heads are disposed within 90 degrees from each other on the rotary cylinder.

8. A magnetic recording apparatus according to claim 2, wherein said at least one pair of magnetic heads are combined magnetic heads disposed on a base at the rotary cylinder.

9. A method for recording signals to form first signal tracks and second signal tracks alternately arranged on a magnetic recording medium at a first azimuth angle and a second azimuth angle, respectively, the method comprising the steps of:
scanning the magnetic recording medium by at least one pair of magnetic heads having magnetic gaps with different azimuth angles,
forming the first signal tracks onto the magnetic recording medium at the same time by a first magnetic head of said at least one pair of magnetic heads preceding a second magnetic head of said at least one pair of magnetic heads, and
forming the second signal tracks between the first signal tracks at the same time by the second magnetic head so that the second signal tracks partly overlap the first signal tracks formed by the first magnetic head and disposed on both sides of the second signal tracks.

10. A method for magnetically recording signals according to claim 9, wherein one of said at least one pair of magnetic heads is a multiple magnetic head in which the magnetic gaps in the plurality of magnetic recording elements have the same azimuth angle.

11. A method for magnetically recording signals according to claim 9, wherein each magnetic gap is defined by a thin-film magnetic head.

12. A method for magnetically recording signals according to claim 9, wherein said at least one pair of magnetic heads are disposed within 90 degrees from each other on the rotary cylinder.

13. A method for magnetically recording signals according to claim 10, wherein said at least one pair of magnetic heads are combined magnetic heads disposed on a base at the rotary cylinder.

14. A method for magnetically recording signals according to claim 10, wherein each magnetic gap is defined by a thin-film magnetic head.

15. A method for magnetically recording signals according to claim 10, wherein said at least one pair of magnetic heads are disposed within 90 degrees from each other on the rotary cylinder.

16. A method for magnetically recording signals according to claim 10, wherein said at least one pair of magnetic heads are combined magnetic heads disposed on a base at the rotary cylinder.
